(19) United States
(12) Patent Application Publication
(10) Pub. No.: US 2009/0305749 A1
(43) Pub. Date: Dec. 10, 2009

(54) Wireless Communication Apparatus Capable of Reducing Power Consumption and Related Apparatus

(76) Inventors: Kang-Wei Fan, Taipei City (TW); Ching-Chung Tang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/467,317

(22) Filed: May 18, 2009

(30) Foreign Application Priority Data
Jun. 10, 2008 (TW) 097121521

(51) Int. Cl. H04M 1/00; H04B 1/04

(52) U.S. Cl. 455/574; 455/127.5

(57) ABSTRACT

An RF transmitter for a wireless communication device for reducing power consumption of the wireless communication device includes an RF signal generation unit for generating an RF signal, a power converter for adjusting voltage of a DC power according to a first control signal and outputting the DC power, a switching unit for generating a mode switch signal according a second control signal, and a power amplifier coupled to the RF signal generation unit, the power converter and the switching unit, for amplifying power of the RF signal according to the DC power and the mode switch signal.

### BACKGROUND OF THE INVENTION

1. Field of the Invention

The present invention relates to a wireless communication device and related radio frequency transmitter, and more particularly, to a wireless communication device capable of reducing power consumption and related radio frequency transmitter for reducing power consumption of the wireless communication device.

2. Description of the Prior Art

A power source for a portable wireless communication device is usually a battery, such as a Li-ion battery. When the battery power is fully consumed under the operating voltage of the portable wireless communication device, a user has to wait for the battery to be recharged before the battery can supply enough power for further operation. In other words, user convenience of the portable wireless communication device may be reduced due to high power consumption, which results in short standby time, and frequent recharging of the battery.

A power amplifier is a component that consumes the greatest amount of power in a radio frequency (RF) circuit in the portable wireless communication device. A conventional power amplifier includes several driving stages in a cascade, for amplifying and outputting an RF signal. Please refer to FIG. 1, which is a schematic diagram of a power amplifier 10 according to the prior art. The power amplifier 10 is a two-stage power amplifier, and includes a first driving stage 104, a second driving stage 106 and a bias unit 110. The power amplifier 10 amplifies power of an input signal VIN via the first driving stage 104 and the second driving stage 106, and then outputs an output signal VOUT.

The bias unit 110 is utilized for providing a regulated DC power for the first driving stage 104 and the second driving stage 106. Power consumption of the first driving stage 104 and the second driving stage 106 is always the same for every level of the input signal VIN. As a result, power consumption of the power amplifier 10 cannot be decreased.

As mentioned previously, a portable wireless communication device with high power consumption inevitably has a short standby time, which reduces user convenience. Therefore, it is an important issue to decrease power consumption of the portable wireless communication device.

### SUMMARY OF THE INVENTION

It is therefore a primary objective of the claimed invention to provide a wireless communication device capable of reducing power consumption and a related radio frequency transmitter.

The present invention discloses an RF transmitter for a wireless communication device, for reducing power consumption of the wireless communication device. The RF transmitter comprises an RF signal generation unit for generating an RF signal, a power converter for adjusting voltage of a DC power according to a first control signal and outputting the DC power, a switching unit for generating a mode switch signal according a second control signal, and a power amplifier coupled to the RF signal generation unit, the power converter and the switching unit, for amplifying power of the RF signal according to the DC power and the mode switch signal.

The present invention further discloses a wireless communication device capable of reducing power consumption. The wireless communication device comprises a power supply, a baseband circuit and an RF transmitter. The power supply is utilized for supplying output power. The baseband circuit is utilized for generating a baseband signal, a first control signal and a second control signal. The RF transmitter is coupled to the power supply and the baseband circuit, and comprises an RF signal generation unit, a power converter, a switching unit and a power amplifier. The RF signal generation unit is coupled to the baseband circuit, for generating an RF signal according to the baseband signal. The power converter is coupled to the power supply and the baseband circuit, for converting the output power of the power supply into a DC power, adjusting voltage of the DC power according to the first control signal and outputting the DC power. The switching unit is coupled to the baseband circuit, for generating a mode switch signal according the second control signal. The power amplifier coupled to the RF signal generation unit, the power converter and the switching unit, for amplifying power of the RF signal according to the DC power and the mode switch signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a power amplifier according to the prior art.

FIG. 2 is a schematic diagram of a wireless communication device according to an embodiment of the present invention.

### DETAILED DESCRIPTION

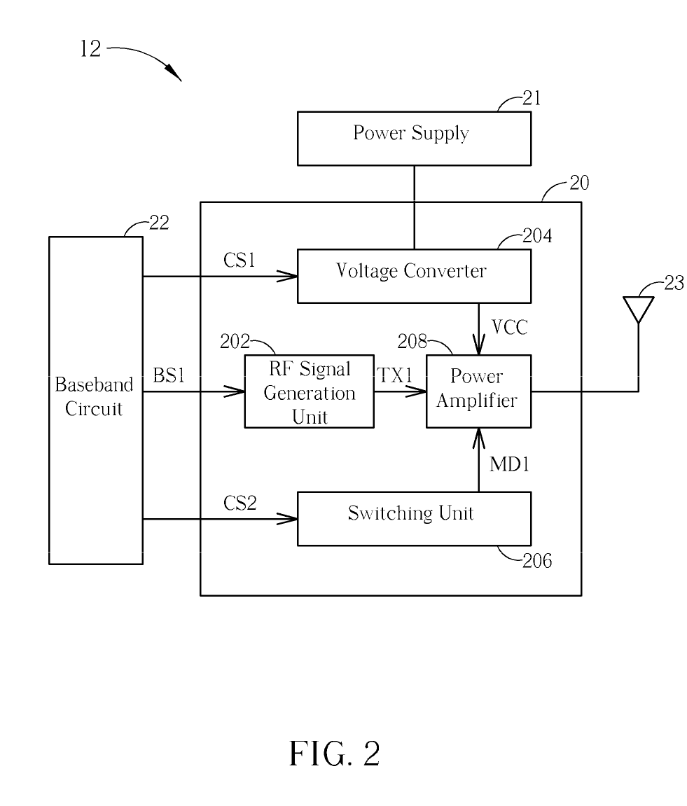

Please refer to FIG. 2, which is a schematic diagram of a wireless communication device 12 according to an embodiment of the present invention. The wireless communication device 12 can be a mobile phone or a personal digital assistant (PDA), for example. The wireless communication device 12 comprises an RF transmitter 20, a power supply 21, a baseband circuit 22 and an antenna 23. The RF transmitter 20 is coupled to the power supply 21, the baseband circuit 22 and the antenna 23, and is utilized for generating an RF signal TX1. The RF transmitter 20 comprises an RF signal generation unit 202, a power converter 204, a switching unit 206 and the power amplifier 208. Details of the RF transmitter 20 are described later. The power supply 21 is utilized for supplying output power for the whole wireless communication device 12. The baseband circuit 22 is utilized for generating a baseband signal BS1, a first control signal CS1 and a second control signal CS2, wherein the first control signal CS1 and the second control signal CS2 are generated according to the RF signal TX1 outputted from the power amplifier 208 in the RF transmitter 20. The antenna 23 is utilized for transmitting the RF signal TX1 to the air.

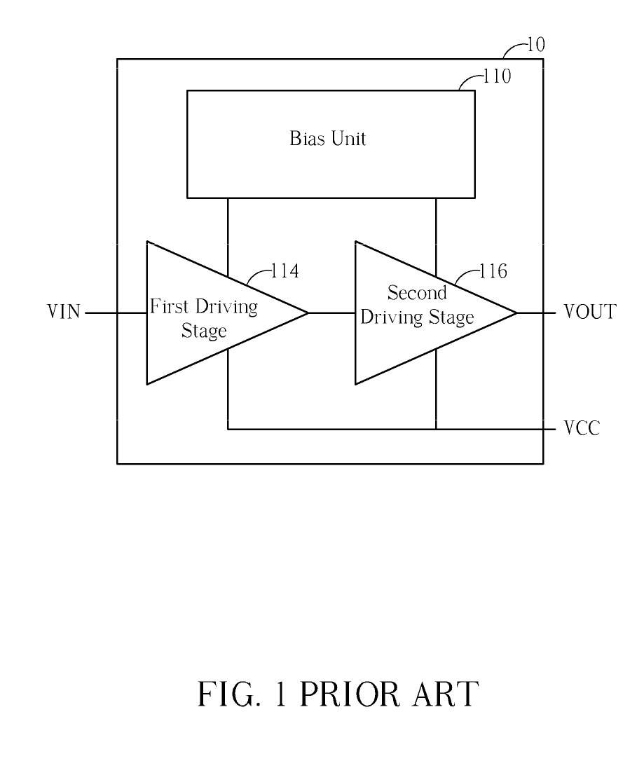

The RF signal generation unit 202 is coupled to the baseband circuit 22 and the power amplifier 208, and is utilized for generating the RF signal TX1 to the power amplifier 208 according to the baseband signal BS1. The power converter 204 is coupled to the power supply 21, the baseband circuit 22 and the power amplifier 208, and is utilized for converting the output power of the power supply 21 into a DC power VCC, adjusting voltage of the DC power VCC according to the first control signal CS1, and outputting the DC power VCC to form an operating voltage of the power amplifier 208. The switching unit 206 is coupled to the baseband circuit 22 and the power amplifier 208, and is utilized for generating a mode switch signal MD1 to the power amplifier 208 according the second control signal CS2. The power amplifier 208 is similar to the conventional power amplifier 10 in FIG. 1. The power amplifier 208 comprises a plurality of driving stages utilized for adjusting a gain setting and power consumption, for amplify power of the RF signal TX1 according to the DC power VCC and the mode switch signal MD1.

Generally, a transmitting power of a wireless communication device is not always at a maximum power. However, the operating voltage of the conventional power amplifier is a fixed voltage and cannot be adjusted according to transmitting power, which results in unnecessary power consumption. Please note that, according to the embodiment of the present invention, the DC power VCC is the operating voltage of the power amplifier 208 and voltage of the DC power VCC can be adjusted according to the first control signal CS1, which is generated according to the RF signal TX1 outputted from the power amplifier 208. In other words, voltage of the DC power VCC can be adjusted according to the required gain of the power amplifier 208, and therefore power consumption of the power amplifier 208 is decreased effectively.

As mentioned previously, power consumption of the conventional power amplifier is fixed since driving stages in the conventional power amplifier are not controlled by external signals. In comparison, in the RF transmitter 20, enabling states of driving stages in the power amplifier 208 can be controlled by the mode switch signal MD1, and thereby operating modes of the power amplifier 208 are determined flexibly. For example, if the power amplifier 208 is a two-stage power amplifier, operating modes of the power amplifier 208 can be defined as a high power mode and a low power mode. In the high power mode, both driving stages of the power amplifier 208 are enabled, whereas in the low power mode only one of the driving stages is enabled. When the required gain of the power amplifier 208 is greater/less than a threshold, such as +20 dBm, the power amplifier 208 is controlled to operate in the high power mode/low power mode according to the mode switch signal MD1. That is, the power amplifier 208 is controlled to operate in a proper power mode according to the mode switch signal MD1, so that unnecessary power consumption is reduced.

From the above, the operating voltage of the power amplifier 208 can be adjusted according to the first control signal CS1, and operating modes of the power amplifier 208 can also be adjusted according to the mode switch signal MD1, which is generated according to the second control signal CS2. As a result, power consumption of the power amplifier 208 is optimized.

In conclusion, the embodiment of the present invention adjusts the operating voltage of the power amplifier and also adjusts operating modes of the power amplifier according to the required transmitting power, so that power consumption of power amplifier is decreased and power consumption of the wireless communication device is decreased correspondingly.

Those skilled in the art will readily observe that numerous modifications and alterations of the device and method may be made while retaining the teachings of the invention.

What is claimed is:

1. A radio frequency (RF) transmitter for a wireless communication device, for reducing power consumption of the wireless communication device, the RF transmitter comprising:
an RF signal generation unit for generating an RF signal;
a power converter for adjusting voltage of a DC power according to a first control signal and outputting the DC power;
a switching unit for generating a mode switch signal according a second control signal; and
a power amplifier coupled to the RF signal generation unit, the power converter and the switching unit, for amplifying power of the RF signal according to the DC power and the mode switch signal.

2. The RF transmitter of claim 1, wherein the power converter is coupled to a power supply, for converting an output power of the power supply into the DC power.

3. The RF transmitter of claim 1, wherein the power converter is coupled to a baseband circuit in the wireless communication device utilized for generating the first control signal.

4. The RF transmitter of claim 3, wherein the baseband circuit generates the first control signal according to the RF signal outputted from the power amplifier.

5. The RF transmitter of claim 1, wherein the switching unit is coupled to a baseband circuit in the wireless communication device utilized for generating the second control signal.

6. The RF transmitter of claim 5, wherein the baseband circuit generates the second control signal according to the RF signal outputted from the power amplifier.

7. The RF transmitter of claim 1, wherein the power amplifier is driven by the DC power outputted by the power converter.

8. The RF transmitter of claim 1, wherein the power amplifier comprises a plurality of driving stages and enabling states of the plurality of driving stages are switched according to the mode switch signal, for controlling gain of the power amplifier.

9. The RF transmitter of claim 1, further comprising an antenna coupled to the power amplifier.

10. The RF transmitter of claim 1, wherein the wireless communication device is a mobile phone.

11. A wireless communication device capable of reducing power consumption comprising:
a power supply for supplying output power;
a baseband circuit for generating a baseband signal, a first control signal and a second control signal; and
a radio frequency (RF) transmitter coupled to the power supply and the baseband circuit, the RF transmitter comprising:
an RF signal generation unit coupled to the baseband circuit, for generating an RF signal according to the baseband signal;
a power converter coupled to the power supply and the baseband circuit, for converting the output power of the power supply into a DC power, adjusting voltage of the DC power according to the first control signal, and outputting the DC power;
a switching unit coupled to the baseband circuit, for generating a mode switch signal according the second control signal; and
a power amplifier coupled to the RF signal generation unit, the power converter and the switching unit, for amplifying power of the RF signal according to the DC power and the mode switch signal.

12. The wireless communication device of claim 11, wherein the baseband circuit generates the first control signal and the second control signal according to the RF signal outputted from the power amplifier.

13. The wireless communication device of claim 11, wherein the power amplifier is driven by the DC power outputted from the power converter.

14. The wireless communication device of claim 11, wherein the power amplifier comprises a plurality of driving stages, and enabling states of the plurality of driving stages are switched according to the mode switch signal for controlling gain of the power amplifier.

15. The wireless communication device of claim 11, wherein the wireless communication device is a mobile phone.
